(19) United States
(12) Patent Application Publication
(10) Pub. No.: US 2007/0028052 A1
(43) Pub. Date: Feb. 1, 2007

(54) Method and apparatus for maintaining cached state data for one or more shared devices in a logically partitioned computer system

(75) Inventors: Troy David Armstrong, Rochester, MN (US); Adam Charles Lange-Pearson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/191,402

(22) Filed: Jul. 28, 2005

(51) Int. Cl. G06F 12/00

(52) U.S. Cl. 711/129

(57) ABSTRACT

A logically partitions computer system maintains a respective window for each of multiple cached state values which are subject to change. Where an individual change to a cached state value does not cause it to stray outside its window, then the change is made only to the cached state value, without triggering an updating operation. Where the change causes the cached state value to stray outside the window, an updating operation is triggered. Preferably, the system contains a global system clock, which is adjusted by an independent clock state delta value for each partition. A respective window is maintained for each clock delta. A global wake-up time for the system, determined as the earliest wake-up time of any partition, is re-computed when a change to a partition's clock causes its cached clock delta to stray outside the window.

### FIELD OF THE INVENTION

The present invention relates to digital data processing, and in particular to the cached state for a shared device of a logically partitioned digital data processing system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system is an enormously complex machine, usually having many sub-parts or subsystems, each of which may be concurrently performing different functions in a cooperative, although partially autonomous, manner. Typically, the system comprises one or more central processing units (CPUs) which form the heart of the system, and which execute instructions contained in computer programs. Instructions and other data required by the programs executed by the CPUs are stored in memory, which often contains many heterogenous components and is hierarchical in design, containing a base memory or main memory and various caches at one or more levels. At another level, data is also stored in mass storage devices such as rotating disk drives, tape drives, and the like, from which it may be retrieved and loaded into memory. The system also includes hardware necessary to communicate with the outside world, such as input/output controllers; I/O devices attached thereto such as keyboards, monitors, printers, and so forth; and external communication devices for communicating with other digital systems. Internal communications buses and interfaces, which may also comprise many components and be arranged in a hierarchical or other design, provide paths for communicating data among the various system components.

A recent development in the management of complex computer system resources is the logical partitioning of system resources. Conceptually, logical partitioning means that multiple discrete partitions are established, and the system resources of certain types are assigned to respective partitions. For example, processor resources of a multi-processor system may be partitioned by assigning different processors to different partitions, by sharing processors among some partitions and not others, by specifying the amount of processing resource measure available to each partition which is sharing a set of processors, and so forth. Tasks executing within a logical partition can use only the resources assigned to that partition, and not resources assigned to other partitions. Memory resources may be partitioned by defining memory address ranges for each respective logical partition, these address ranges not necessarily coinciding with physical memory devices.

A logical partition emulates a complete computer system. Within any logical partition, the partition appears to be a complete computer system to tasks executing at a high level. Each logical partition has its own operating system (which might be its own copy of the same operating system, or might be a different operating system from that of other partitions). The operating system appears to dispatch tasks, manage memory paging, and perform typical operating system tasks, but in reality is confined to the resources of the logical partition. Thus, the external behavior of the logical partition (as far as the task is concerned) should be the same as a complete computer system, and should produce the same results when executing the task.

Logical partitions are generally defined and allocated by a system administrator or user with similar authority. I.e., the allocation is performed by issuing commands to appropriate management software resident on the system, rather than by physical reconfiguration of hardware components. It is expected, and indeed one of the benefits of logical partitioning is, that the authorized user can re-allocate system resources in response to changing needs or improved understanding of system performance. Some logical partitioning systems support dynamic partitioning, i.e., the changing of certain resource definition parameters while the system is operational, without the need to shut down the system and re-initialize it.

A logical partition may have some discrete hardware components assigned for its exclusive use, but typically there are at least some hardware components which are shared. An example of a shared hardware component is a system clock. Although it is theoretically possible to provide a separate hardware clock for each logical partition, in most logically partitioned systems the system clock is a single hardware device which is shared by all partitions.

In order to emulate a complete computer system, a logical partition may require state delta information with respect to common hardware. For example, in the case of a system clock, software normally has the ability to read the clock and to reset it independently of other computer systems. In this manner, each computer system may have an independent record of time, which might vary by time zone or other local factors, and might be synchronized independently to the same or different external sources. A logical partition should therefore behave in the same manner. Because there is but one hardware clock, each partition maintains a respective clock state delta from the single master clock, the clock state deltas of the various partitions being independent. In order to read the clock in any partition, the master clock is read, and the value so read is adjusted by the amount of the clock state delta. In order to reset the clock, the clock is read and the clock state delta is reset to the difference between the reset value and the value of the master clock. Thus, each partition appears to have an independent clock, which it is free to read and reset, without troubling the other partitions.

There are certain clock-based events which can have global significance or significance outside the logical partition. As a single (although by no means the only) example, in a sophisticated computer system, it is often possible to specify a wake-up time for automatically powering-up from an idle state, the system hardware being powered off or in a power conserving mode while idle. If such a system is logically partitioned, then each partition may independently specify its own wake-up time. However, from the standpoint of certain system resources which are necessarily used by all partitions, the only significant wake-up time is the first to occur. At the first wake-up, power supplies will be brought on line, shared storage devices powered up, and so on. It is possible that certain hardware, dedicated to one or more particular partitions which are still in a de-activated state, need not be powered up at this time, but in general the first wake-up to occur is the most significant. In such a system, some system resource will track the earliest wake-up time and trigger the necessary operations accordingly.

If a logical partition resets its clock, it will generally be necessary for the system resource which tracks wake-up time to determine whether there has been a change to the earliest wake-up time, and thus each resetting of a partition's clock can have a ripple effect outside the partition itself. Similar ripple effects could occur for other types of timed events. Individually, these ripple effects may seem small. However, in many environments it is common to re-synchronize the clock to some external source on a frequent basis. Typically, these re-synchronizations involve very small clock shifts, but the ripple effect is the same. Although not necessarily generally recognized, where the number of logical partitions is large and the clocks are being reset frequently, the consequent operations needed to assure correct synchronization and operation can have a significant effect on system performance.

Moreover, in addition to clock-based events, there are other instances of cached state data for a shared resource in a logically partitioned computer system which is subject to frequent change and/or frequent access, and accessing and maintaining such data can involve significant overhead. There exists a need for improved techniques for maintaining and accessing shared resources in a logically partitioned computer system, which are not unduly burdensome, particularly where partitions are accessing and/or updating state data on a frequent basis.

### SUMMARY OF THE INVENTION

A low-level function of a computer system which enforces logical partitioning maintains a respective window for each of multiple cached state values which are subject to change. Where an individual change to a cached state value does not cause it to stray outside its window, then the change is made only to the cached state value, without triggering an updating operation. Where the change causes the cached state value to stray outside the window, an updating operation is triggered for re-determining at least one cached state value.

In the preferred embodiment, the computer system contains a global system clock, and a separate and independent clock state delta value is associated with each respective partition, the global system clock being adjusted by the partition's clock state delta to determine the clock value for a partition. A respective window is maintained for each clock delta. A wake-up or power-on function time value is associated with each of multiple logical partitions of the computer system. The wake-up or power-on function will cause the corresponding logical partition to resume an operating state when a global system clock reaches the associated wake-up time value. A global wake-up time value is maintained as the earliest wake-up time of the various partitions. Changes to the clock state delta value associated with a partition have the effect of changing the wake-up time of the partition. These changes can be frequent, although they are typically very small. As long as the cumulative change to a clock delta does not cause it to drift outside the window, the global wake-up time value is not re-determined. If the cumulative change to the clock delta value associated with any one of the logical partitions causes the value to go outside the window, the system re-computes the global wake up time by comparing the wake-up times of all the partitions.

This generalized technique could be applied to other functions than the wake-up function. The use of a window to monitor a cached state value might apply generally to any of various state values which are incremental in nature. In addition to values relating to time, such cached state values might include, e.g., available capacity of a resource which changes incrementally and predictably.

The use of windows associated with cached state values of different logical partitions, as described herein, reduces the frequency with which certain state values must be re-determined or other synchronization action taken, thus reducing the overhead burden of maintaining cached state values in a logically partitioned computer system.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a logically partitionable computer system which maintains cached state data, according to the preferred embodiment of the present invention.

FIG. 2 is a conceptual illustration showing the existence of logical partitions at different hardware and software levels of abstraction in a computer system, according to the preferred embodiment.

FIG. 3 is a representation of significant state data and process interactions for maintaining cached state data, according to the preferred embodiment.

FIG. 4 is a flow diagram showing the process of determining a virtual time for a partition, according to the preferred embodiment.

FIG. 5 is a flow diagram showing the process of waking up a computer system from idle state in response to a previously scheduled wake-up time, according to the preferred embodiment.

FIG. 6 is a flow diagram showing the process of resetting a partition's virtual time, according to the preferred embodiment.

FIG. 7 is a flow diagram showing the process of updating the global wake-up value, according to the preferred embodiment.

### DETAILED DESCRIPTION OF THE PREFERRED EMBODIMENT

Logical Partitioning Overview

Logical partitioning is a technique for dividing a single large computer system into multiple partitions, each of which behaves in some respects as a separate computer system. Certain resources of the system may be allocated into discrete sets, such that there is no sharing of a single resource among different partitions, while other resources may be shared on a time interleaved or other basis. Examples of resources which may be partitioned are central processors, main memory, I/O processors and adapters, and I/O devices. Each user task executing in a logically partitioned computer system is assigned to one of the logical partitions (“executes in the partition”), meaning that it can use only the system resources assigned to that partition, and not resources assigned to other partitions.

Logical partitioning is indeed logical rather than physical. A general purpose computer typically has physical data connections such as buses running between a resource in one partition and one in a different partition, and from a physical configuration standpoint, there is typically no distinction made with regard to logical partitions. Generally, logical partitioning is enforced by a partition manager embodied as low-level encoded executable instructions and data, although there may be a certain amount of hardware support for logical partitioning, such as hardware registers which hold state information. The system's physical devices and subcomponents thereof are typically physically connected to allow communication without regard to logical partitions, and from this hardware standpoint, there is nothing which prevents a task executing in partition A from writing to memory or an I/O device in partition B. The low level code function and/or hardware prevent access to the resources in other partitions.

Code enforcement of logical partitioning constraints means that it is possible to alter the logical configuration of a logically partitioned computer system, i.e., to change the number of logical partitions or re-assign resources to different partitions, without reconfiguring hardware. Generally, some portion of the logical partition manager comprises an interface with low-level code function that enforces logical partitioning. This logical partition manager interface is intended for use by a single or a small group of authorized users, who are herein designated the system administrator. In the preferred embodiment described herein, the partition manager is referred to as a “hypervisor”.

Logical partitioning of a large computer system has several potential advantages. As noted above, it is flexible in that reconfiguration and re-allocation of resources is easily accomplished without changing hardware. It isolates tasks or groups of tasks, helping to prevent any one task or group of tasks from monopolizing system resources. It facilitates the regulation of resources provided to particular users; this is important where the computer system is owned by a service provider which provides computer service to different users on a fee-per-resource-used basis. Finally, it makes it possible for a single computer system to concurrently support multiple operating systems and/or environments, since each logical partition can be executing a different operating system or environment.

Additional background information regarding logical partitioning can be found in the following commonly owned patents and patent applications, which are herein incorporated by reference: Ser. No. 10/977,800, filed Oct. 29, 2004, entitled System for Managing Logical Partition Preemption; Ser. No. 10/857,744, filed May 28, 2004, entitled System for Correct Distribution of Hypervisor Work, Ser. No. 10/624,808, filed Jul. 22, 2003, entitled Apparatus and Method for Autonomically Suspending and Resuming Logical Partitions when I/O Reconfiguration is Required; Ser. No. 10/624,352, filed Jul. 22, 2003, entitled Apparatus and Method for Autonomically Detecting Resources in a Logically Partitioned Computer System; Ser. No. 10/424,641, filed Apr. 25, 2003, entitled Method and Apparatus for Managing Service Indicator Lights in a Logically Partitioned Computer System; Ser. No. 10/422,680, filed Apr. 24, 2003, entitled On-Demand Allocation of Data Structures to Partitions; Ser. No. 10/422,426, filed Apr. 24, 2003, entitled High Performance Synchronization of Resource Allocation in a Logically-Partitioned Computer System; Ser. No. 10/422,425, filed Apr. 24, 2003, entitled Selective Generation of an Asynchronous Notification for a Partition Management Operation in a Logically-Partitioned Computer; Ser. No. 10/422,214, filed Apr. 24, 2003, entitled Address Translation Manager and Method for a Logically Partitioned Computer System; Ser. No. 10/422,190, filed Apr. 24, 2003, entitled Grouping Resource Allocation Commands in a Logically-Partitioned System; Ser. No. 10/418,349, filed Apr. 17, 2003, entitled Configuration Size Determination in a Logically Partitioned Environment; Ser. No. 10/411,455, filed Apr. 10, 2003, entitled Virtual Real Time Clock Maintenance in a Logically Partitioned Computer System; Ser. No. 09/838,057, filed Apr. 19, 2001, entitled Method and Apparatus for Allocating Processor Resources in a Logically Partitioned Computer System; Ser. No. 09/836,687, filed Apr. 17, 2001, entitled A Method for Processing PCI Interrupt Signals in a Logically Partitioned Guest Operating System; U.S. Pat. No. 6,820,164 to Holm et al., entitled A Method for PCI Bus Detection in a Logically Partitioned System; U.S. Pat. No. 6,662,242 to Holm et al., entitled Method for PCI I/O Using PCI Device Memory Mapping in a Logically Partitioned System; Ser. No. 09/672,043, filed Sep. 29, 2000, entitled Technique for Configuring Processors in System With Logical Partitions; U.S. Pat. No. 6,438,671 to Doing et al., entitled Generating Partition Corresponding Real Address in Partitioned Mode Supporting System; U.S. Pat. No. 6,467,007 to Armstrong et al., entitled Processor Reset Generated Via Memory Access Interrupt; U.S. Pat. No. 6,681,240 to Armstrong et al, entitled Apparatus and Method for Specifying Maximum Interactive Performance in a Logical Partition of a Computer; Ser. No. 09/314,324, filed May 19, 1999, entitled Management of a Concurrent Use License in a Logically Partitioned Computer; U.S. Pat. No. 6,691,146 to Armstrong et al., entitled Logical Partition Manager and Method; U.S. Pat. No. 6,279,046 to Armstrong et al., entitled Event-Driven Communications Interface for a Logically-Partitioned Computer; U.S. Pat. No. 5,659,786 to George et al.; and U.S. Pat. No. 4,843,541 to Bean et al. The latter two patents describe implementations using the IBM S/360, S/370, S/390 and related architectures, while the remaining patents and applications describe implementations using the IBM i/Series™, AS/400™, and related architectures.

### DETAILED DESCRIPTION

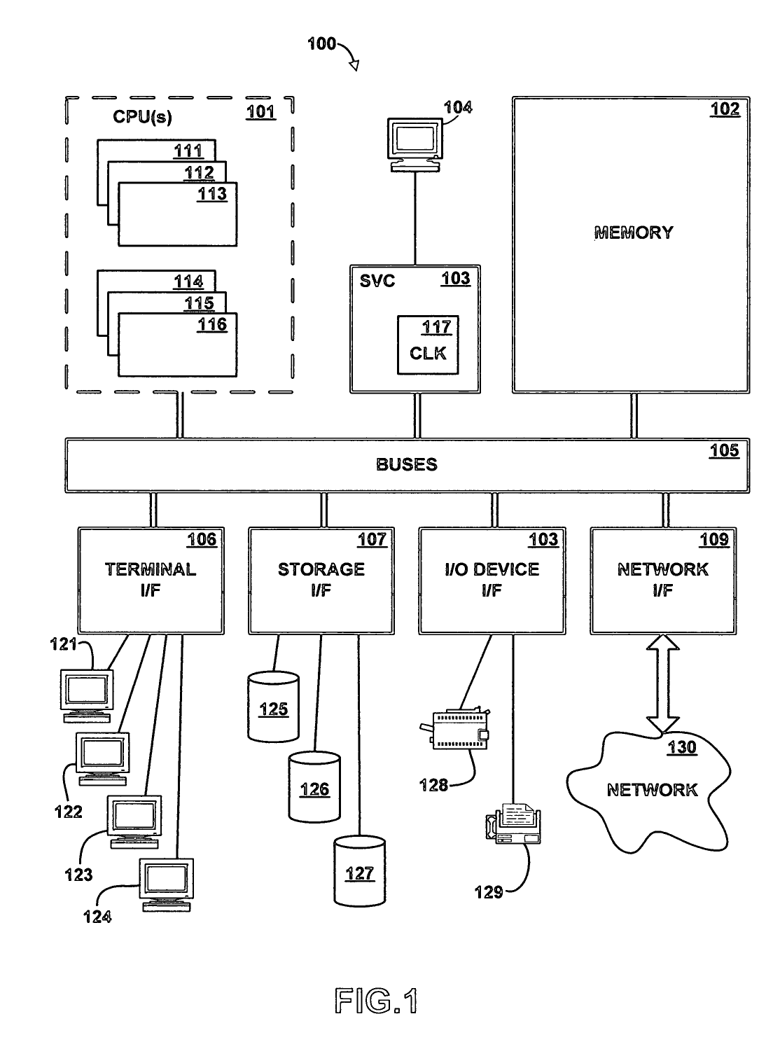

Referring to the Drawing, wherein like numbers denote like parts throughout the several views, FIG. 1 is a high-level representation of the major hardware components of a logically partitionable computer system 100 having multiple physical hardware components, according to the preferred embodiment of the present invention. At a functional level, the major components of system 100 are shown in FIG. 1 outlined in dashed lines; these components include one or more central processing units (CPU) 101, main memory 102, service processor 103, terminal interface 106, storage interface 107, I/O device interface 108, communications/network interfaces 109, all of which are coupled for inter-component communication via one or more buses 105.

CPU 101 is one or more general-purpose programmable processors, executing instructions stored in memory 102; system 100 may contain a single CPU, but more typically contains multiple CPUs, either alternative being collectively represented by feature CPU 101 in FIG. 1, and may include one or more levels of on-board cache (not shown). Typically, a logically partitioned system will contain multiple CPUs, the multiple CPUs being represented as CPUs 111-116. Memory 102 is a random-access semiconductor memory for storing data and programs. Memory 102 is conceptually a single monolithic entity, it being understood that memory is often arranged in a hierarchy of caches and other memory devices. Additionally, memory 102 may be divided into portions associated with particular CPUs or sets of CPUs and particular buses, as in any of various so-called non-uniform memory access (NUMA) computer system architectures.

Service processor 103 is a special-purpose functional unit used for initializing the system, maintenance, and other low-level functions. In general, it does not execute user application programs, as does CPU 101. In the preferred embodiment, among other functions, service processor 103 and attached hardware management console (HMC) 104 provide an interface for a system administrator or similar individual, allowing that person to manage logical partitioning of system 100 by defining partitions, allocating resources, and so forth. Service processor 103 further includes a master system clock 117 which is the internal base from which references to time are determined, as explained in greater detail herein. However, system 100 need not necessarily have a dedicated service processor, and clock 117, as will as the certain logical partitioning control functions, could be located elsewhere or performed by other system components.

Terminal interface 106 provides a connection for the attachment of one or more user terminals 121-124, and may be implemented in a variety of ways. Many large server computer systems (mainframes) support the direct attachment of multiple terminals through terminal interface I/O processors, usually on one or more electronic circuit cards. Alternatively, interface 106 may provide a connection to a local area network to which terminals 121-124 are attached. Various other alternatives are possible. Data storage interface 107 provides an interface to one or more data storage devices 125-127, which are preferably rotating magnetic hard disk drive units, although other types of data storage device could be used. I/O and other device interface 108 provides an interface to any of various other input/output devices or devices of other types. Two such devices, printer 128 and fax machine 129, are shown in the exemplary embodiment of FIG. 1, it being understood that many other such devices may exist, which may be of differing types. Communications interface 109 provides one or more communications paths from system 100 to other digital devices and computer systems; such paths may include, e.g., one or more networks 130 such as the Internet, local area networks, or other networks, or may include remote device communication lines, wireless connections, and so forth.

Buses 105 provide communication paths among the various system components. Although a single conceptual bus entity 105 is represented in FIG. 1, it will be understood that a typical computer system may have multiple buses, often arranged in a complex topology, such as point-to-point links in hierarchical, star or web configurations, multiple hierarchical busses, parallel and redundant paths, etc., and that separate buses may exist for communicating certain information, such as addresses or status information. In the preferred embodiment, in addition to various high-speed data buses used for communication of data as part of normal data processing operations, a special service bus connects the various hardware units, allowing the service processor or other low-level processes to perform various functions independently of the high-speed data buses, such as powering on and off, reading hardware unit identifying data, and so forth. However, such a service bus is not necessarily required.

It should be understood that FIG. 1 is intended to depict the representative major components of an exemplary system 100 at a high level, that individual components may have greater complexity than represented FIG. 1, and that the number, type and configuration of such functional units and physical units may vary considerably. It will further be understood that not all components shown in FIG. 1 may be present in a particular computer system, and that other components in addition to those shown may be present. Although system 100 is depicted as a multiple user system having multiple terminals, system 100 could alternatively be a single-user system, typically containing only a single user display and keyboard input, or might be a server or similar device which has little or no direct user interface, but receives requests from other computer systems (clients).

As represented in FIG. 1, at the level of physical hardware there is no concept of partitioning. For example, any processor can access busses which communicate with memory and other components, and thus access any memory address, I/O interface processor, and so forth. Partitioning, i.e., restrictions on the access to certain system resources, is accomplished by low-level partition management code.

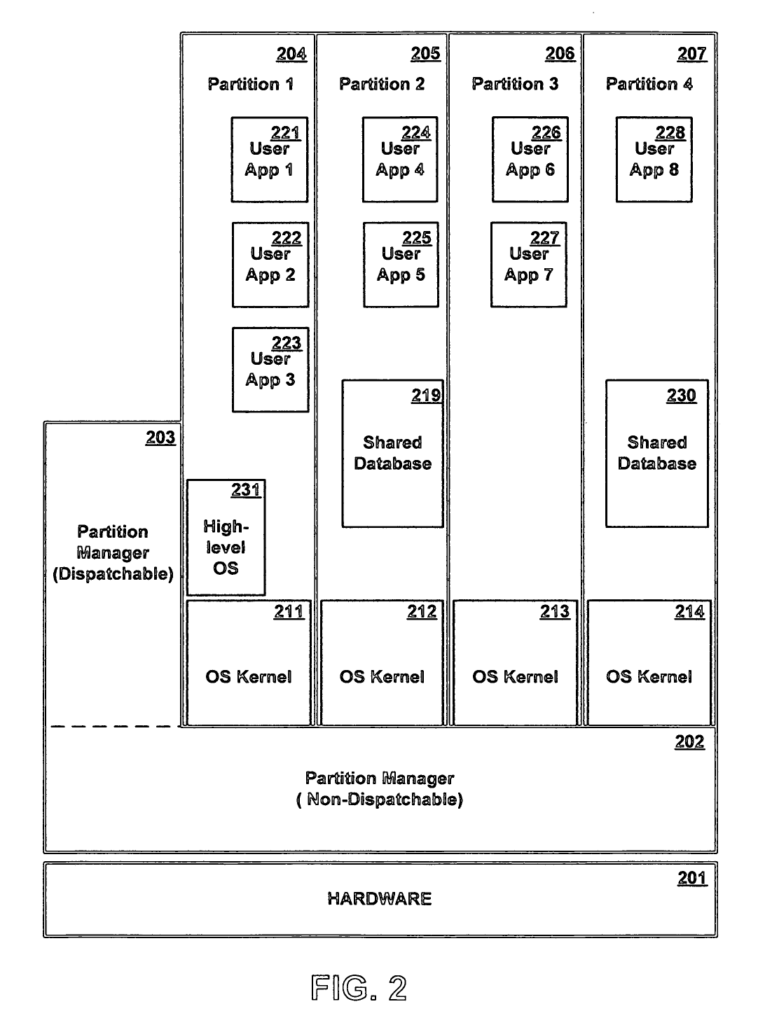

FIG. 2 is a conceptual illustration showing the existence of logical partitions at different hardware and software levels of abstraction in computer system 100. FIG. 2 represents a system having four logical partitions 204-207 available for user applications, designated “Partition 1”, “Partition 2”, etc., it being understood that the number of partitions may vary. As is well known, a computer system is a sequential state machine which performs processes. These processes can be represented at varying levels of abstraction. At a high level of abstraction, a user specifies a process and input, and receives an output. As one progresses to lower levels, one finds that these processes are sequences of instructions in some programming language, which continuing lower are translated into lower level instruction sequences, and pass through licensed internal code and ultimately to data bits which get put in machine registers to force certain actions. At a very low level, changing electrical potentials cause various transistors to turn on and off. In FIG. 2, the “higher” levels of abstraction are represented toward the top of the figure, while lower levels are represented toward the bottom.

As shown in FIG. 2 and explained earlier, logical partitioning is a code-enforced concept. At the hardware level 201, logical partitioning does not exist. As used herein, hardware level 201 represents the collection of physical devices (as opposed to data stored in devices), such as processors, memory, buses, I/O devices, etc., shown in FIG. 1, possibly including other hardware not shown in FIG. 1. As far as a processor of CPU 101 is concerned, it is merely executing machine level instructions. In the preferred embodiment, each processor of CPU 101 is identical and more or less interchangeable. While code can direct tasks in certain partitions to execute on certain processors, there is nothing in the processor itself which dictates this assignment, and in fact the assignment can be changed by the code. Therefore the hardware level is represented in FIG. 2 as a single entity 201, which does not itself distinguish among logical partitions.

Partitioning is enforced by a partition manager (also known as a “hypervisor”), consisting of a non-relocatable, non-dispatchable portion 202 (also known as the “non-dispatchable hypervisor” or “partitioning licensed internal code” or “PLIC”), and a relocatable, dispatchable portion 203. The hypervisor is super-privileged executable code which is capable of accessing resources, and specifically processor resources and memory, in any partition. The hypervisor maintains state data in various special purpose hardware registers, and in tables or other structures in general memory, which govern boundaries and behavior of the logical partitions. Among other things, this state data defines the allocation of resources in logical partitions, and the allocation is altered by changing the state data rather than by physical reconfiguration of hardware.

In the preferred embodiment, the non-dispatchable hypervisor 202 is non-relocatable, meaning that the code which constitutes the non-dispatchable hypervisor is at a fixed hardware address in memory. Non-dispatchable hypervisor 202 has access to the entire real memory range of system 100, and can manipulate real memory addresses. The dispatchable hypervisor code 203 (as well as all partitions) is contained at addresses which are relative to a logical partitioning assignment, and therefore this code is relocatable. The dispatchable hypervisor behaves in much the same manner as a user partition (and for this reason is sometimes designated “Partition 0”), but it is hidden from the user and not available to execute user applications. In general, non-dispatchable hypervisor 202 handles assignment of tasks to physical processors, memory enforcement, and similar essential partitioning tasks required to execute application code in a partitioned system, while dispatchable hypervisor 203 handles maintenance-oriented tasks, such as creating and altering partition definitions.

As represented in FIG. 2, there is no direct path between higher levels (levels above non-dispatchable hypervisor 202) and hardware level 201, meaning that commands or instructions generated at higher levels must pass through non-dispatchable hypervisor level 202 before execution on the hardware. Non-dispatchable hypervisor 202 enforces logical partitioning of processor resources by presenting a partitioned view of hardware to the task dispatchers at higher levels. I.e., task dispatchers at a higher level (the respective operating systems) dispatch tasks to virtual processors defined by the logical partitioning parameters, and the hypervisor in turn dispatches virtual processors to physical processors at the hardware level 201 for execution of the underlying task. The hypervisor also enforces partitioning of other resources, such as allocations of memory to partitions, and routing I/O to I/O devices associated with the proper partition.

Dispatchable hypervisor 203 performs many auxiliary system management functions which are not the province of any partition. The dispatchable hypervisor generally manages higher level partition management operations such as creating and deleting partitions, concurrent hardware maintenance, allocating processors, memory and other hardware resources to various partitions, etc.

Above non-dispatchable hypervisor 202 are a plurality of logical partitions 204-207. Each logical partition behaves, from the perspective of processes executing within it, as an independent computer system, having its own memory space and other resources. Each logical partition therefore contains a respective operating system kernel herein identified as the “OS kernel” 211-214. At the level of the OS kernel and above, each partition behaves differently, and therefore FIG. 2 represents the OS Kernel as four different entities 211-214 corresponding to the four different partitions. In general, each OS kernel 211-214 performs roughly equivalent functions. However, it is not necessarily true that all OS kernels 211-214 are identical copies of one another, and they could be different versions of architecturally equivalent operating systems, or could even be architecturally different operating system modules. OS kernels 211-214 perform a variety of task management functions, such as task dispatching, paging, enforcing data integrity and security among multiple tasks, and so forth.

Above the OS kernels in each respective partition there may be a set of high-level operating system functions, and user application code, databases, and other entities accessible to the user. Examples of such entities are represented in FIG. 2 as user applications 221-228, shared databases 229-230, and high-level operating system 231, it being understood that these are shown by way of illustration only, and that the actual number and type of such entities may vary. The user may create code above the level of the OS Kernel, which invokes high level operating system functions to access the OS kernel, or may directly access the OS kernel. In the IBM i/Series™ architecture, a user-accessible architecturally fixed “machine interface” forms the upper boundary of the OS kernel, (the OS kernel being referred to as “SLIC”), but it should be understood that different operating system architectures may define this interface differently, and that it would be possible to operate different operating systems on a common hardware platform using logical partitioning.

Processes executing within a partition may communicate with processes in other partitions in much the same manner as processes in different computer systems may communicate with one another, i.e., using any of various communications protocols which define various communications layers. At the higher levels, inter-process communications between logical partitions is the same as that between different systems. But at lower levels, it is not necessary to traverse a physical transmission medium to a different system, and executable code in the partition manager or elsewhere (not shown) may provide a virtual communications connection.

A special user interactive interface is provided into dispatchable hypervisor 203, for use by a system administrator, service personnel, or similar privileged users. This user interface can take different forms, and is referred to generically as the Service Focal Point (SFP). In the preferred embodiment, i.e., where system 100 contains a service processor 103 and attached hardware management console 104, the HMC 104 functions as the Service Focal Point application for the dispatchable hypervisor. In the description herein, it is assumed that HMC 104 provides the interface for the hypervisor.

While various details regarding a logical partitioning architecture have been described herein as used in the preferred embodiment, it will be understood that many variations in the mechanisms used to enforce and maintain logical partitioning are possible consistent with the present invention, and in particular that administrative mechanisms such as a service partition, service processor, hardware management console, dispatchable hypervisor, and so forth, may vary in their design, or that some systems may employ some or none of these mechanisms, or that alternative mechanisms for supporting and maintaining logical partitioning may be present.

It will be understood that FIG. 2 is a conceptual representation of partitioning of various resources in system 100. In general, entities above the level of hardware 201 exist as addressable data entities in system memory 102. However, it will be understood that not all addressable data entities will be present in memory at any one time, and that data entities are typically storage in storage devices 125-127 and paged into main memory 102 as required.

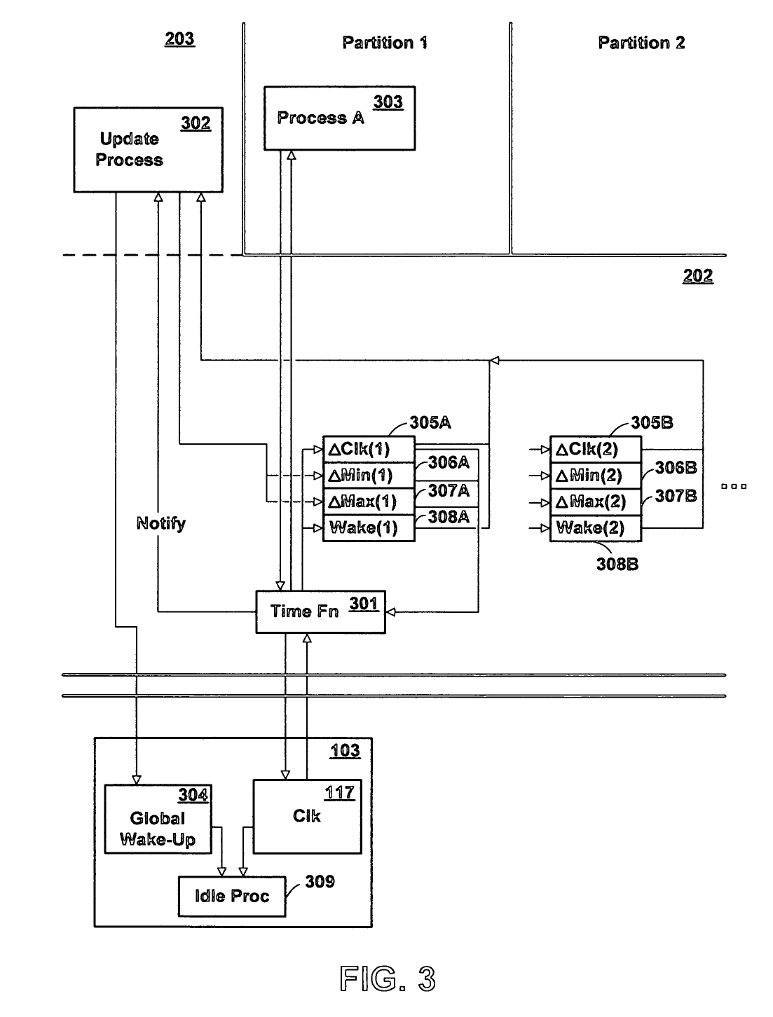

In the preferred embodiment, the hypervisor maintains certain state information with respect to each logical partition, and maintains a respective window for at least some state data, which is in particular clock state data. The result of individual changes to the clock state are compared to the window to determine whether the cumulative change is sufficiently large to warrant a re-determination of a cached state, in particular, a cached global wake-up time. If the cumulative change is sufficiently large, the cached global wake-up time is re-determined by evaluating the relevant quantities for all applicable partitions. FIG. 3 is a representation of significant state data and process interactions for maintaining a cached global wake-up time, according to the preferred embodiment.

Referring to FIG. 3, non-dispatchable hypervisor 202 includes a time function 301 for responding to certain time-related requests from a process executing within a partition, represented in FIG. 3 as Process A 303 in Partition 1 204, it being understood that time function 301 is shared by all partitions and responds to time-related requests from processes in any partition. In particular, time function 301 responds to a clock query request, a reset clock request, and a reset wake-up time request. For each logical partition N, the hypervisor maintains a respective clock delta value 305A, 305B (“ΔClk(N)”, herein generically referred to as feature 305), a respective delta lower limit 306A, 306B (“ΔMin(N)”, herein generically referred to as feature 306), a respective delta upper limit 307A, 307B (“ΔMax(N)”, herein generically referred to as feature 307), and a respective wake-up time 308A, 308B (“Wake(N)”, herein generically referred to as feature 308). For clarity of illustration, these state values 305-308 are shown for only two partitions 204, 205 in FIG. 3, it being understood that the state values are replicated for each partition. A global wake up time 304 is recorded in a register in service processor 103. In appropriate circumstances, explained further herein, time function 301 calls an update process 302 in dispatchable hypervisor 203 for re-determining the value of global wake-up time 304. Global wake up time 304 represents a time at which a system idle process 309 in the service processor should wake up the system.

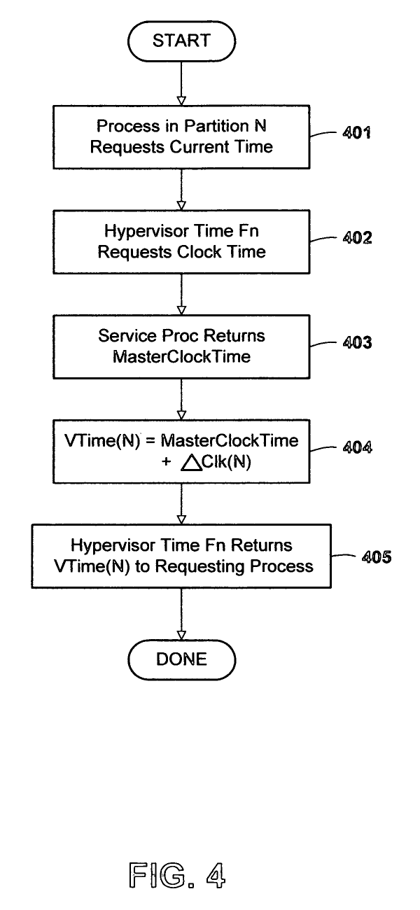

A separate and independent virtual time clock is associated with each partition, the time according to the virtual clock being determined by time function 301 using master clock 117 and the clock delta 305 corresponding to the partition. Since each partition's clock delta 305 is independently maintained, these virtual time clocks are effectively independent. FIG. 4 illustrates the process of reading the virtual time clock of a partition. As shown in FIG. 4, a requesting process in Partition N requests the current time from the operating system, this request being directed to time function 301 in non-dispatchable hypervisor 202 (step 401). Responsive to receiving the request, time function 301 requests the current clock time from the master clock 117 in service processor 103 (step 402). The service processor returns the current time according to the master clock (step 403). Time function 301 computes the virtual clock time for partition N (“VTime(N)”) by taking the sum of the master clock time and the value of clock delta 305 for partition N (step 404). Time function 301 then returns the virtual clock time to the requesting process (step 405).

Each partition has the capability to independently specify a respective wake-up time, the wake-up times being relative to the virtual time in each partition. I.e., a partition is to be awakened when the partition's virtual time (determined as described above with respect to FIG. 4) reaches the stored wake-up time value 308 for the partition. This value could be a null value or equivalent, indicating that the partition has no scheduled wake-up time, i.e., it is only awakened on the occurrence of some event or events other than the clock reaching a particular time. The partition wake-up time typically applies to software processes executing in the partition. Most, if not all, system hardware components are shared by multiple partitions, and must be powered up if any partition is active. Therefore the time at which the earliest partition to wake up does so is significant. This earliest wake-up time is stored as global wake-up time 304 in service processor 103, and represented as an absolute value (a value with respect to master system clock 117) rather than a value relative to the virtual time of any particular partition.

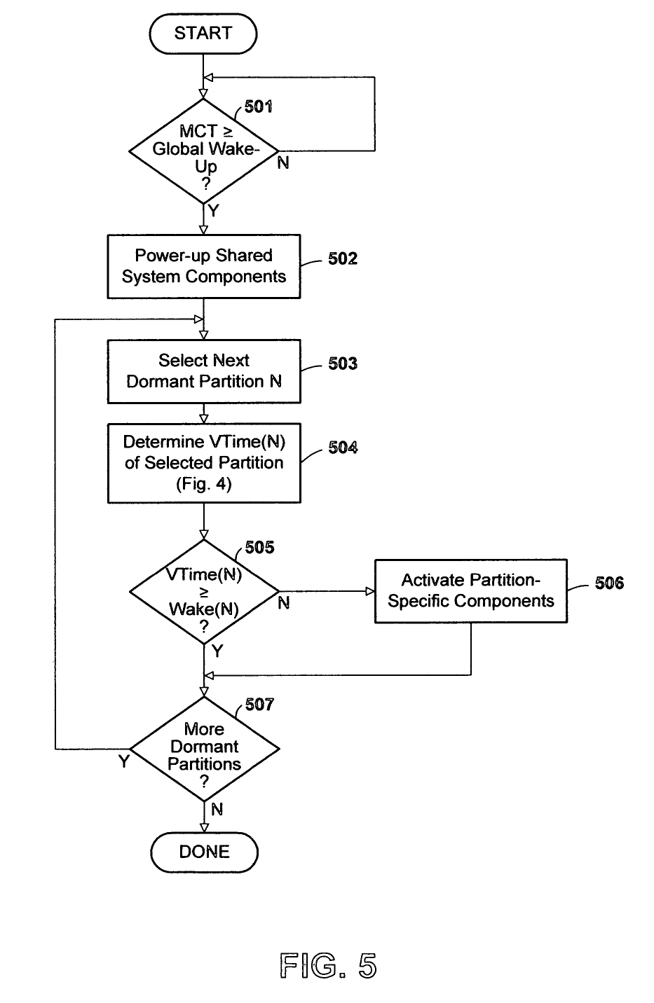

When the system is idle (and all partitions are de-activated), most system components are powered off and not consuming any electrical power. However, at least some components in the service processor are active even in a system idle state. In idle state, an idle process 309 monitors conditions which might cause the system to wake-up. One of those conditions is the occurrence of a previously scheduled wake-up time. The process of waking up the system in response to a previously scheduled wake-up time is shown in FIG. 5.

Referring to FIG. 5, with a system initially in idle state, an idle process 309 compares global wake-up time to the MasterClockTime (MCT) from master system clock 117 (step 501) and exits the idle loop (the ‘Y’ branch from step 501) if master system clock reaches the global wake-up time. Although the idle state at step 501 is shown as a “loop” in FIG. 5, it will be appreciated that the state of the clock being equal to or greater than the global wake-up time might be detected either by a software process or by hardware comparators, and the representation of FIG. 5 is not meant to imply any particular embodiment.

Upon leaving the idle state, the service processor initiates power-up and activation of the shared system components (step 502), i.e. those system components which are not associated with any particular logical partition. In the preferred embodiment, this means that essentially all hardware components of the system are powered-up. Powering-up may occur in a defined sequence to impose a pre-determined state, as is known in the art. Certain shared software processes, and in particular hypervisor processes, are also activated.

One of the processes activated is a hypervisor process to determine which partitions are ready to be awakened, as represented by steps 503-507. The partition activation process determines, with respect to each partition, whether the applicable wake-up time has been reached. As shown, the partition activation process selects a next dormant partition N (step 503). The process then determines the current virtual time of the selected dormant partition N (VTime(N)) by adjusting the system master clock time by the partition's clock delta 305, as explained above with respect to FIG. 4 (step 504). If the partition's virtual time equals or exceeds the partition's wake-up time 308 (step 505), then the partition is activated (step 506). Activation of a partition typically means that a software process for the partition, such as the applicable OS Kernel, is initiated, although it could conceivably also require that hardware used only by the partition be activated as well. If there are any more dormant partitions, the ‘Y’ branch is taken from step 507 and a next dormant partition is selected. Conceptually, the partition activation process continues at least until all partitions have been activated, which could mean it continues for a relatively long time, since some partitions may deliberately have a significantly later wake-up time. The actual implementation of such a process may vary. E.g., after an initial pass through all the partitions, a partition activation process might be called at periodic intervals to determine whether any more dormant partitions should be activated. The partition activation process preferably remains alive indefinitely even after all partitions are activated (because partitions could be de-activated, and later awakened again).

As explained above, global wake-up time 304 is intended to represent the earliest of the various partition wake-up times. Global wake-up time is a time relative to the master clock, i.e., it is not a virtual time which is adjusted by a clock delta associated with any partition. However, the partition wake-up times 308 are virtual times, which are compared to the respective virtual times of the partitions generated by adjusting the master clock value by the respective partition's clock delta 305. Therefore, when determining the global wake-up time, it is necessary to take into account not only the wake-up time 308 of each respective partition, but its clock delta 305 as well. In theory, any change to either the wake-up time or the clock delta in any partition could affect the global wake-up time, and the global wake-up time should therefore be re-determined. The various partition wake-up times are typically changed very infrequently, but in many environments the clock deltas are changed often. These changes typically amount to re-synchronizing a partition's virtual clock to some external time standard, and therefore individual changes to the clock deltas are generally very small in magnitude. To avoid the need to recompute the global wake-up time for each and every one of these small changes, a respective window represented by delta lower limit 306 and delta upper limit 307 is associated with each partition's clock delta, and as long as the cumulative change to the clock delta remains in the window, the global wake-up time is not re-computed. The effect of this practice is that, in some cases, the global wake-up time will not be strictly accurate, but the error in the global wake-up time will be confined to the magnitude of the windows. A window might be, e.g., on the order of several minutes wide. For a global wake-up time, an inaccuracy on the order of several minutes is tolerable.

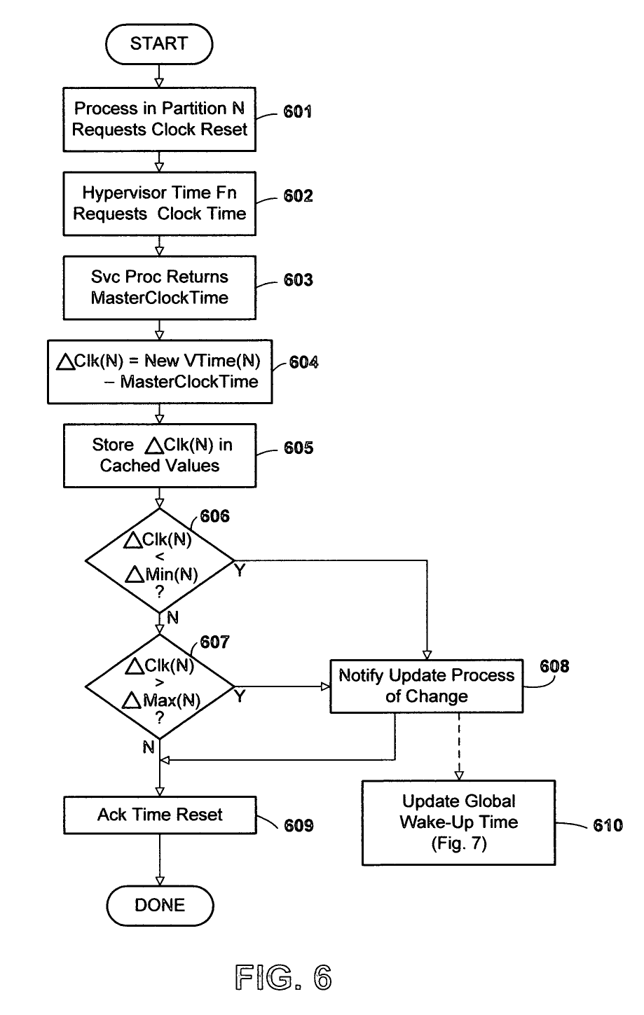

The process of updating a partition's virtual time is shown in FIG. 6. Referring to FIG. 6, a requesting process in Partition N requests that the virtual time for the partition be reset to some value (New VTime(N)) provided by the requesting process, this request being directed to time function 301 in non-dispatchable hypervisor 202 (step 601). Responsive to receiving the request, time function 301 requests the current clock time from the master clock 117 in service processor 103 (step 602). The service processor returns the current time according to the master clock (step 603). Time function 301 re-computes the clock delta for partition N as the difference between the new virtual time for partition N and the time from the master clock (step 604). This recomputed value of the partition's clock delta is stored in clock delta storage location 305 (step 605).

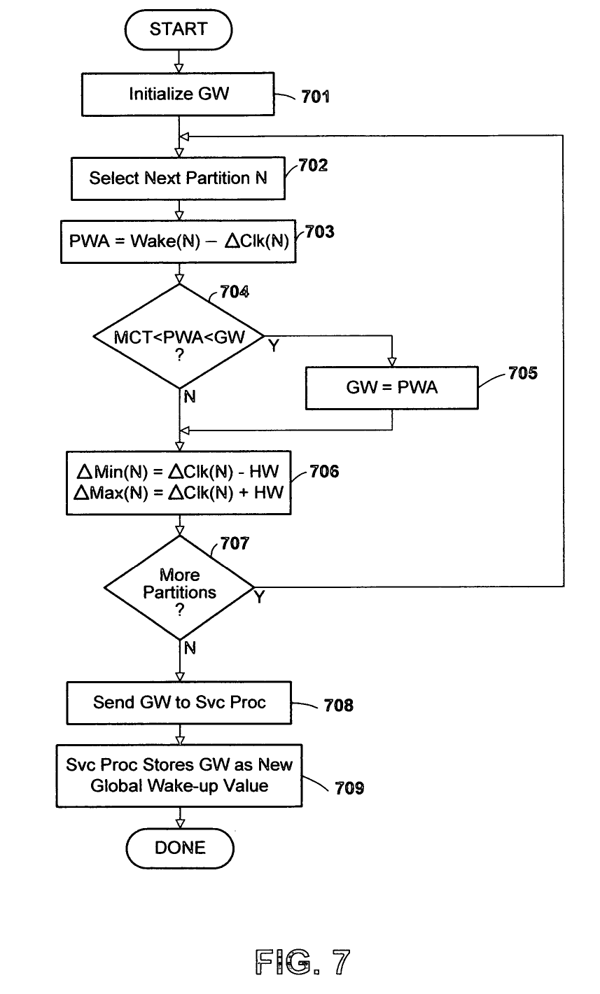

If the new clock delta computed at step 604 is less than delta lower limit 306 (step 606) or greater than delta upper limit 307 (step 607), then the ‘Y’ branch is taken from the respective step, and the global wake-up time update process 302 in dispatchable hypervisor 203 is notified that there has been a clock change which requires re-computation of the global wake-up time 304 (step 608). Whether or not the delta limits are exceeded, the time function then acknowledges to the requesting process that the partition's virtual time has been reset (step 609), completing the updating of the partition's time. If the global wake-up time update process was notified of a change at step 608, then the global wake-up update process will asynchronously update the global wake-up time (step 610), a process shown in greater detail in FIG. 7.

FIG. 7 shows the process of updating the global wake-up value. The update process 302 is triggered when time function 301 indicate to global wake-up time update process 302 that a clock change has occurred, or upon the occurrence of some other appropriate condition. The update process may be triggered, e.g., when a system is re-initialized, when new partitions are defined or existing partitions are removed, when a partition changes its wake-up time, etc. In particular, as explained above with respect to FIG. 6, the update function is triggered when a resetting of a partition's virtual clock causes its clock delta to stray outside the limits of the window defined by the delta lower limit 306 and delta upper limit 307.

Referring to FIG. 7, the update process initializes various internal state variables, including in particular a temporary global wake-up value, designated GW (step 701). The initial value of GW is infinity or some equivalent value (such as null) indicating no scheduled wake-up time. For computational purposes in the following algorithm, null values are treated as at time infinity.

The update process then selects a next partition N to be evaluated (step 702), and computes an absolute partition wake-up time (PWA) as the partition's wake-up time (Wake(N)) adjusted by the clock delta of the partition (step 703). The absolute wake-up time is thus a wake-up time expressed in relation to the master clock, rather than the partition's virtual clock. If the partition has no wake-up time (Wake(N) is set to infinity, null or some other appropriate value), then PWA is similarly set to infinity or some equivalent value. If the PWA so computed is greater than the current master clock time (MCT) and is less than the current GW, the ‘Y’ branch is taken from step 704, GW is set to the value of PWA (step 705). The delta lower limit and delta upper limit for the selected partition are then reset to clock delta less HW and clock delta plus HW, respectively, where HW represents a constant equal to half the width of the clock delta window (step 706). Resetting of the window is necessary to assure that a recalculation of the global wake-up value is not triggered again every time the virtual clock incrementally changes. If more partitions remain to be evaluated, the ‘Y’ branch is taken from step 707, and the update process selects a next partition at step 703. When all partitions have been so evaluated, the ‘N’ branch is taken from step 707.

At this point, the value of GW is the lowest (i.e., the earliest) absolute wake-up time among the various partitions. The update process then requests the service processor to reset the global wake-up value 304 to the value GW so computed (step 708). Responsive to receiving this request, the service processor stores the value GW as the new global wake-up value (step 709).

In the preferred embodiment, the wake-up time 308 of each respective partition is a relative wake-up time expressed in terms of the virtual clock time for the respective partition, while global wake-up time 304 is an absolute wake-up time, expressed in terms of the master clock 117. It would, however, be possible to represent the partition wake-up times 308 as absolute wake-up times, expressed in terms of the master clock. In this case, the partition wake-up times could be re-computed on the same basis that the global wake-up time is re-computed. Alternatively, the partition wake-up time could be re-computed with every change of the clock delta, and the window could be associated with the partition wake-up time rather than the clock delta.

In general, the routines executed to implement the illustrated embodiments of the invention, whether implemented as part of an operating system or a specific application, program, object, module or sequence of instructions, including a module within a special device such as a service processor, are referred to herein as “programs” or “control programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, recordable type media such as volatile and non-volatile memory devices, floppy disks, hard-disk drives, CD-ROM's, DVD's, magnetic tape, and transmission-type media such as communications networks. Examples of signal-bearing media are illustrated in FIG. 1 as system memory 102 and data storage devices 122.

A generalized technique for maintaining state data according to the present invention could be applied to other functions than the wake-up function. The invention could apply to any of various events which are timed to occur at a value of a clock. For example, a data backup or other maintenance operation might be timed to occur regularly at a pre-scheduled time. It may be desirable to have such operations occur in a particular sequence for different partitions, or to stagger the operations for different partitions, so that they do not all occur simultaneously. In this case, it may be useful to monitor the timer values at which the operations are to occur using respective windows, as described herein, and perform some adjustment when a timer value is not within its window. This generalized technique could further be applied to functions which are not associated with the system clock.

Although a specific embodiment of the invention has been disclosed along with certain alternatives, it will be recognized by those skilled in the art that additional variations in form and detail may be made within the scope of the following claims:

What is claimed is:

1. A method for managing cached state values in a computer system, comprising the steps of:
defining a plurality of logical partitions of said computer system and resources allocated to each respective partition;
defining a respective set of one or more partition state values for each of said plurality of logical partitions;
associating with a first state value of each said set of partition state values a corresponding window;
automatically determining whether a change to a first state value causes the first state value to be outside its corresponding window; and
automatically re-determining at least one cached state value if said determining step determines that the first state value is no longer within its corresponding window.

2. The method of claim 1, where said step of automatically re-determining of at least one cached state value comprises comparing a plurality of compared values, each compared value derived from a respective said set of one or more partition state values.

3. The method of claim 2, wherein each said set of partition state values includes a partition wake-up time value specifying a time for waking the corresponding partition, and wherein said automatically re-determining step redetermines a global wake-up time value derived from said partition wake-up time values.

4. The method of claim 1, wherein each said first state value is a clock delta value for deriving a virtual time associated with a respective partition from a master clock which is common to all said plurality of logical partitions.

5. The method of claim 4, wherein each said set of partition state values includes a partition wake-up time value specifying a time for waking the corresponding partition, said partition wake-up time value being expressed relative to said virtual time associated with a respective partition to which the partition wake-up time value corresponds, and wherein said automatically re-determining step redetermines a global wake-up time value derived from said partition wake-up time values.

6. The method of claim 4, further comprising the steps of:
receiving requests to change respective virtual times associated with respective partitions; and
responsive to receiving each said request to change a respective virtual time, automatically re-computing the clock delta value corresponding to the partition with which the virtual time is associated;
wherein said step of automatically determining whether a change to a first state value causes the first state value to be outside its corresponding window comprises comparing the re-computed clock delta value produced by said step of automatically re-computing the clock delta value with said corresponding window.

7. The method of claim 1, wherein each said set of partition state values is maintained in a software facility which enforces logical partitioning, said steps of determining whether a change to a first state value causes the first state value to be outside its corresponding window being performed by a process of said software facility which enforces logical partitioning.

8. A computer program product for managing cached state values in a computer system, comprising:
a plurality of computer-executable instructions recorded on signal-bearing media, wherein said instructions, when executed by at least one computer system, cause the at least one computer system to perform the steps of:
maintaining a respective set of one or more partition state values for each of a plurality of logical partitions of said computer system, each logical partition having a respective set of resources allocated to it, wherein a corresponding window is associated with a first state value of each said set of partition state values;
determining whether a change to a first state value causes the first state value to be outside its corresponding window; and
re-determining at least one cached state value if said determining step determines that the first state value is no longer within its corresponding window.

9. The computer program product of claim 8, where said step of re-determining of at least one cached state value comprises comparing a plurality of compared values, each compared value derived from a respective said set of one or more partition state values.

10. The computer program product of claim 9, wherein each said set of partition state values includes a partition wake-up time value specifying a time for waking the corresponding partition, and wherein said re-determining step redetermines a global wake-up time value derived from said partition wake-up time values.

11. The computer program product of claim 8, wherein each said first state value is a clock delta value for deriving a virtual time associated with a respective partition from a master clock which is common to all said plurality of logical partitions.

12. The computer program product of claim 11, wherein each said set of partition state values includes a partition wake-up time value specifying a time for waking the corresponding partition, said partition wake-up time value being expressed relative to said virtual time associated with a respective partition to which the partition wake-up time value corresponds, and wherein said automatically re-determining step redetermines a global wake-up time value derived from said partition wake-up time values.

13. The computer program product of claim 11, wherein said instructions when executed by said at least one computer system, further cause the at least one computer system to perform the steps of:
receiving requests to change respective virtual times associated with respective partitions; and
responsive to receiving each said request to change a respective virtual time, automatically re-computing the clock delta value corresponding to the partition with which the virtual time is associated;
wherein said step of determining whether a change to a first state value causes the first state value to be outside its corresponding window comprises comparing the re-computed clock delta value produced by said step of automatically re-computing the clock delta value with said corresponding window.

14. A computer system, comprising:
at least one processor;
a memory;
a logical partitioning facility which enforces logical partitioning of said computer system into a plurality of logical partitions, each logical partition having a respective set of resources of said computer system allocated to it, said logical partitioning facility maintaining a respective set of one or more partition state values for each of said plurality of logical partitions;
wherein a corresponding window is associated with a first state value of each said set of partition state values;
wherein said logical partitioning facility automatically determines whether changes to said first state values cause a said first state value to be outside its corresponding window; and
wherein said logical partitioning facility, responsive to determining that a change to a said first state value has caused the first state value to be outside its corresponding window, triggers automatic re-determination of at least one cached state value by said computer system.

15. The computer system of claim 14, wherein said logical partitioning facility is embodied as a plurality of low-level processor-executable instructions storable in said memory and which execute in said at least one processor.

16. The computer system of claim 14, where said computer system performs an automatic re-determination of said at least one cached state value by comparing a plurality of compared values in said logical partitioning facility, each compared value derived from a respective said set of one or more partition state values.

17. The computer system of claim 14, wherein each said set of partition state values includes a partition wake-up time value specifying a time for waking the corresponding partition, and wherein said computer system performs an automatic re-determination of said at least one cached state value by automatically re-determining a global wake-up time value derived from said partition wake-up time values.

18. The computer system of claim 14, wherein each said first state value is a clock delta value for deriving a virtual time associated with a respective partition from a master clock which is common to all said plurality of logical partitions.

19. The computer system of claim 18, wherein each said set of partition state values includes a partition wake-up time value specifying a time for waking the corresponding partition, said partition wake-up time value being expressed relative to said virtual time associated with a respective partition to which the partition wake-up time value corresponds, and wherein said computer system performs an automatic re-determination of said at least one cached state value by redetermining a global wake-up time value derived from said partition wake-up time values.

20. The computer system of claim 18, wherein said logical partitioning facility receives requests to change respective virtual times associated with respective partitions, and responsive to each said request to change a respective virtual time, automatically re-computes the clock delta value corresponding to the partition with which the virtual time is associated, said logical partitioning facility determining whether a change to a first state value causes the first state value to be outside its corresponding window by comparing the re-computed clock delta value with said corresponding window.
